(19) United States
(12) Patent Application Publication
(10) Pub. No.: US 2003/0039790 A1
(43) Pub. Date: Feb. 27, 2003

(54) Cut sheet label product having alternating recipient address labels and return address labels and method for using

(75) Inventor: Jason Janetzke, Springboro, OH (US)

Correspondence Address: DOUGLAS S. FOOTE, NRC CORPORATION, 1700 S. PATTERSON BLVD. WHQ5E, DAYTON, OH, 45479, US

(73) Assignee: NCR Corporation

(21) Appl. No.: 09/938,972

(22) Filed: Aug. 24, 2001

(51) Int. Cl. B32B 7/06

(52) U.S. Cl. 428/42.3

(57) ABSTRACT

A cut sheet label product for use in a cut sheet printer includes a plurality of alternating recipient address labels and return address labels in a plurality of columns. Each return address label abuts two recipient address labels except for the first or last return address label of each column of labels. Each return address label has a width and a height smaller than the width and the height, respectively, of each recipient address label. The return address labels and the recipient address labels are printed in a single pass through the cut sheet printer and are sized for use on small postal items, such as envelopes and postcards, and none of the labels on the cut sheet label product are suitable for carrying postal indicia.

The present invention relates to a cut sheet label product having alternating recipient address labels and return address labels and method for using.

### BACKGROUND OF THE INVENTION

Currently, users of personal computers and similar computer devices are able to print address labels on connected printers. As is conventional in the art, the address labels are self-adhesive, formed of a paper-type layer having an adhesive layer on one side. The paper-type layer may include various plastics or other materials to achieve the desired composition as long as the layer is capable of being printed on by a conventional cut sheet printer, for example, ink jet, laser, etc. As the label sheets are cut into standard sizes, such as eight and one-half inches by eleven inches, the label sheets are conventionally referred to as cut sheet label products and are printed in cut sheet printers. In contrast, label rolls are supplied as continuous rolls which may be quite long and may include perforations or the like to separate printed portions of the roll.

The paper-type layer of the address labels may appear clear, white, or any other desired color. The adhesive layer contacts a low adhesion backing material such as a silicon coated material, other release coating or the like. The backing material shields the adhesive layer during the printing operation. When the printed label is to be used, the paper-type layer and the adhesive layer are peeled from the backing material and applied to the desired article, such as an envelope, a package, etc.

Typically, recipient address labels are larger than return address labels. Therefore, label sheets with recipient address labels are not interchangeable with label sheets with return address labels. For example, a recipient address label sheet may include approximately thirty blank recipient address labels. In contrast, a return address label sheet may include approximately eighty blank return address labels. Various computer programs, for example Microsoft Word software by Microsoft of Redmond, Wash., have label templates that enable a user to input the desired addresses for printing on the label sheets accurately.

As companies have developed computer systems to print postage indicia using personal computers or similar terminals connected to general printers, cut sheet label products have been developed for use in printing postal indicia and related address information on labels for an envelope or package See U.S. Pat. No. 6,244,763, for example. However, these label products provide specialized labels in accordance with United States Postal Regulations for printing postal indicia in cooperation with specially designed computer systems. Therefore these label sheets include either labels with a fluorescent stripe or with an enlarged size to comply with the Regulations.

Accordingly, there is a need for a cut sheet label product having a plurality of alternating recipient address labels and return address labels, wherein none of the labels on the label product are suitable for carrying postal indicia thereon.

### SUMMARY OF THE INVENTION

This need is met by the invention of the present application wherein a cut sheet label product for use in a cut sheet printer is provided. The label product has a plurality of alternating return address labels and recipient address labels in a plurality of columns wherein each return address label abuts two recipient address labels except for the first or last return address label of each column of labels. Each return address label has a width and a height which is smaller than the width and the height, respectively, of each recipient address label. The return address labels and the recipient address labels are printed in a single pass through the cut sheet printer. The return address labels and the recipient address labels are sized for use on small postal items such as envelopes, postcards and the like and none of the labels on the label product are suitable for printing postal indicia thereon.

### BRIEF DESCRIPTION OF THE DRAWINGS

The benefits and advantages of the present invention will become apparent to those skilled in the art to which this invention relates from the subsequent description of the illustrated embodiments and the appended claims, taken in conjunction with the accompanying drawings, in which:

FIG. 1 shows a cut sheet label product in accordance with the present invention; and

FIG. 2 shows a use of a recipient address label and a return address label after printing and removal from the cut sheet label product of FIG. 1 with an envelope having conventional postage, e.g., a stamp issued by the United States Postal Service, already attached.

### DETAILED DESCRIPTION OF THE INVENTION

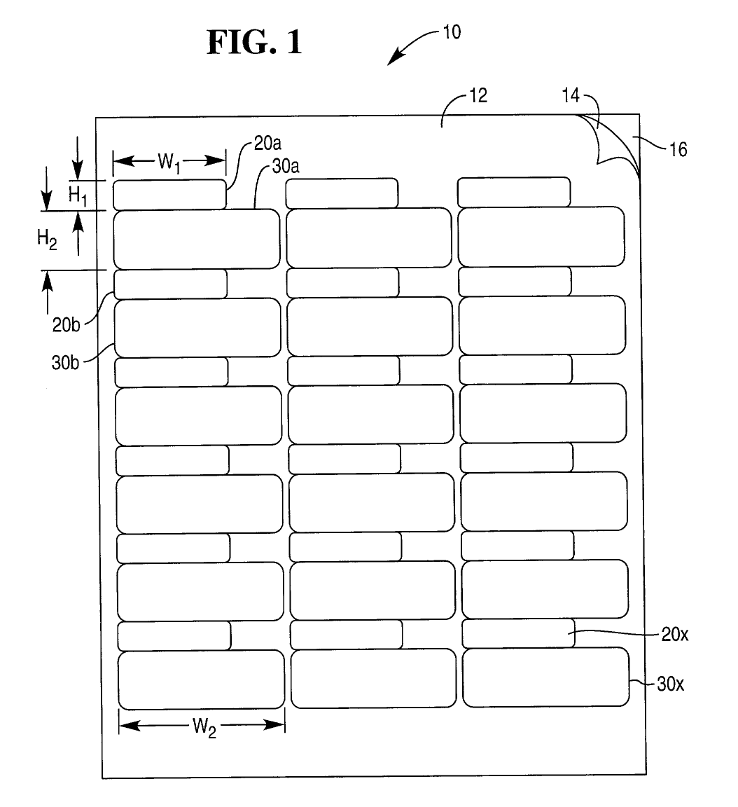

Referring now to the drawings, in which like-referenced characters indicate corresponding elements throughout the several views, attention is first drawn to FIG. 1 which shows a cut sheet label product 10. The cut sheet label product 10 includes a plurality of self-adhesive labels 20a-20x, 30a-30x, formed of a paper-type layer 12 having an adhesive layer 14 on one side. The paper-type layer 12 may include various plastics or other materials to achieve the desired composition as long as the layer 12 is capable of being printed on by a conventional cut sheet printer, for example, ink jet, laser, etc. The paper-type layer 12 may appear clear, white, or any other desired color. The adhesive layer 14 contacts a low adhesion backing material 16 such as a silicon coated material, other release coating or the like. The backing material 16 shields the adhesive layer 14 during the printing operation.

The cut sheet label product 10 includes return address labels 20a-20x in alternating arrangement with recipient address labels 30a-30x, where x is a letter corresponding to the number of labels on the label product, 18 as shown in FIG. 1. The following discussion will describe representative return address label 20a and recipient address label 30a; and it is understood that it also describes all return address labels 20a-20x and all recipient address labels 30a-30x.

Return address label 20a and recipient address label 30a comprise a set of labels to be used on a single small postal item such as an envelope, postcard or the like. Return address label 20a has a width W1 and a height H1. Recipient address label 30a has a width W2 and a height H2. W1 is smaller than W2 and H1 is smaller than H2. For example, W1 can be approximately one and three-fourths inches and W2 can be approximately two and five-eighths inches while H1 can be approximately one-half inch and H2 can be approximately one inch. Additionally, the cut sheet label product 10 of FIG. 1 includes approximately one-half inch margins on each side and one inch margins on the top and bottom. The margin areas are sized to minimize the area not available for printed labels, but are generally required by conventional cut sheet printers. The overall dimensions of the cut sheet label product 10 are approximately eight and one-half inches by eleven inches, a standard size for conventional cut sheet printers. The dimensions W1, W2, H1 and H2 were selected to provide adequate label area to print necessary information in a readable format. Obviously, the dimensions of W1, W2, H1, H2, the margins and the overall sheet height and width can be varied within the scope of the present invention.

Return address labels 20a-20x and recipient address labels 30a-30x are arranged in three columns of six rows of label sets. All labels in each column are located to abut neighboring labels as much as possible to maximize the number of label sets available on a standard sized cut sheet label product. A small gap may be left between columns of labels to assist in removal of the labels and to assist in identifying return address labels 20a-20x and recipient address labels 30a-30x that comprise a set of associated labels. Of course, the gap is desired to be small to minimize the amount of unused space on the cut sheet label product 10. Return address labels 20a-20x and recipient address labels 30a-30x are alternated to provide a set of labels for a single small postal item for printing in a single pass of the printer.

Although the first labels in each column in FIG. 1 are return address labels 20a-20x, it is contemplated within the present invention to provide recipient address labels 30a-30x first in each column and then provide the corresponding return address labels 20a-20x of the sets abutting the recipient address labels 30a-30x.

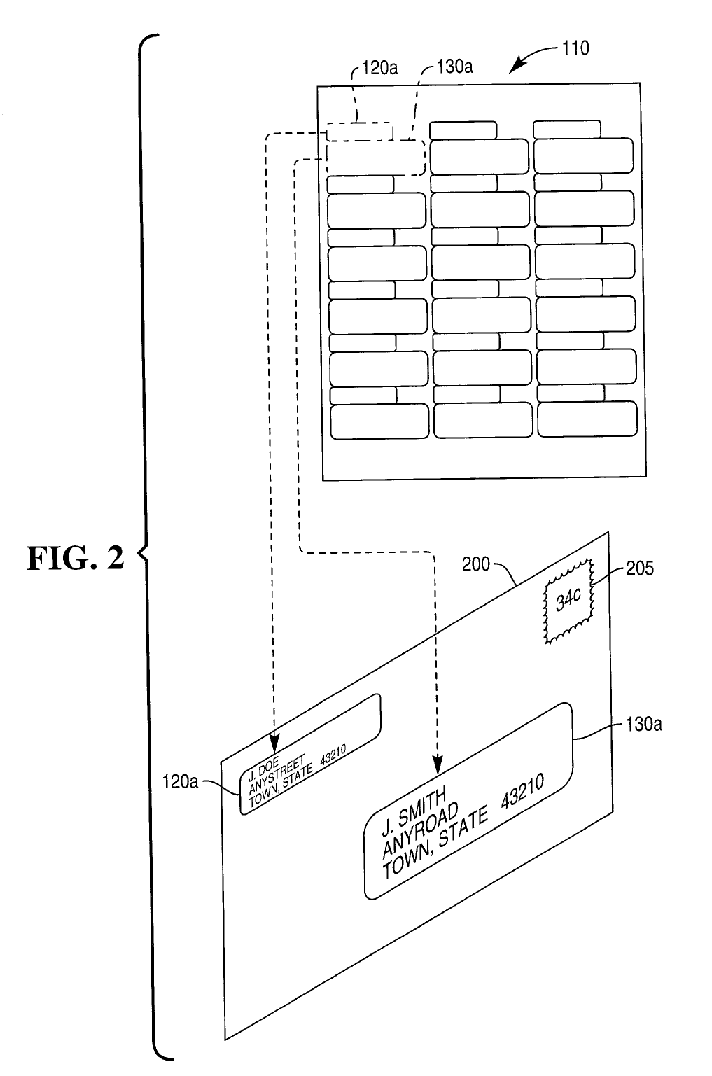

Turning to FIG. 2, a method of using the cut sheet label product 10 of FIG. 1 (after printing) with an envelope 200 having conventional postage, e.g., a stamp issued by the United States Postal Service or a mark by a postal meter such as sold by Pitney-Bowes of Stamford, Conn., already attached is shown. The cut sheet label product 110 has been fed through a cut sheet printer (not shown), and a user removes a desired set of return address label 120a and recipient address label 130a. The removed printed labels 120a and 130a are placed in the appropriate locations on the envelope 200 having conventional postage 205. Of course, it is contemplated within the scope of the present invention to place the labels 120a and 130a on the envelope and then have the conventional postage applied.

Advantageously, the present invention provides a product and means for printing both a return address label and a recipient address label on a single cut sheet label product.

Advantageously, because the cut sheet label product of the present invention does not include labels suitable for printing postage indicia thereon, a computer and printer system that has no capacity to print postage may be used.

Advantageously, the cut sheet label product of the present invention can be used to provide sets of printed return address labels and recipient address labels to be used on a single postal item without providing extraneous labels designed in accordance with US Postal Regulations to support printing of postal indicia, requiring more complex computer systems or additional programming, etc.

Although the invention has been described with particular reference to certain illustrated embodiments thereof, variations and modifications of the present invention can be effected within the spirit and scope of the following claims.

What is claimed is:

1. A cut sheet label product for use in a cut sheet printer comprising:
a plurality of alternating recipient address labels and return address labels formed in a plurality of columns wherein each return address label abuts two recipient address labels except for the first return address label of each column of labels, said return address labels and said recipient address labels being printable in a single pass through the cut sheet printer;
each recipient address label having a width and a height;
each return address label having a width and a height that is smaller than said width and said height, respectively, of each recipient address label;
said return address labels and said recipient address labels being sized for use on small postal items; and
wherein none of said labels on said label product are suitable for carrying postal indicia.

2. The cut sheet label product as claimed in claim 1 wherein said cut sheet label product comprises a paper-type layer, an adhesive layer and a low adhesion backing material

3. The cut sheet label product as claimed in claim 1 having a width of approximately eight and one-half inches and a height of approximately eleven inches.

4. A cut sheet label product for use in a cut sheet printer comprising:
a plurality of alternating recipient address labels and return address labels formed in a plurality of columns wherein each return address label abuts two recipient address labels except for the last return address label of each column of labels, said return address labels and said recipient address labels being printable in a single pass through the cut sheet printer;
each recipient address label having a width and a height;
each return address label having a width and a height that is smaller than said width and said height, respectively, of each recipient address label;
said return address labels and said recipient address labels being sized for use on small postal items; and
wherein none of said labels on said label product are suitable for carrying postal indicia.

5. The cut sheet label product as claimed in claim 4 wherein said cut sheet label product comprises a paper- type layer, an adhesive layer and a low adhesion backing material.

6. The cut sheet label product as claimed in claim 4 having a width of approximately eight and one-half inches and a height of approximately eleven inches.

7. A method for using a cut sheet label product in a cut sheet printer, said method comprising the steps of:
forming a cut sheet label product to have a plurality of alternating recipient address and return address labels in a plurality of columns wherein each return address label abuts two recipient address labels except for the first return address label of each column of labels or the last return address label of each column of labels, none of said labels on said label product being suitable for carrying postal indicia;
sizing said return address labels and said recipient address labels for use on small postal items;
forming each recipient address label to have a width and a height;
forming each return address label to have a width and a height which is smaller than the width and the height, respectively, of each recipient address label;
printing a return address and a recipient address on said cut sheet label product in a single pass through said cut sheet printer;
removing said printed return address label and said printed recipient address label from said cut sheet label product; and
applying said removed printed return address label and said removed printed recipient address label to a single small postal item.

8. method as claimed in claim 7 wherein said single small postal item has conventional postage applied thereto.

9. A method as claimed in claim 7 wherein said label product comprises a paper-type layer, an adhesive layer and a low adhesion backing material.
